(19) United States
(12) Patent Application Publication
(10) Pub. No.: US 2014/0179389 A1
(43) Pub. Date: Jun. 26, 2014

(54) SYSTEM AND METHOD FOR ADMINISTERING ONLINE POKER TOURNAMENTS

(71) Applicants: Dennis Nadeau, Pompano, FL (US); Virginia Balabanova, Pompano Beach, FL (US); Greg Hanis, Fort Lauderdale, FL (US)

(72) Inventors: Dennis Nadeau, Pompano, FL (US); Virginia Balabanova, Pompano Beach, FL (US); Greg Hanis, Fort Lauderdale, FL (US)

(21) Appl. No.: 14/098,801

(22) Filed: Dec. 6, 2013

Related U.S. Application Data
(60) Provisional application No. 61/734,145, filed on Dec. 6, 2012.

(51) Int. Cl. G07F 17/32

(52) U.S. Cl. CPC G07F 17/3293
USPC 463/13

(57) ABSTRACT

The system and method of administering an online poker tournament includes evaluation of players at tournament tables and the fair movement or reallocation of players at tournament participants are eliminated by attrition.

### BACKGROUND OF THE INVENTION

### Field of the Invention

On-line poker has become a very popular phenomenon in our current electronic age. There are many sites and many ways in which on-line tournaments are conducted. However, one difficulty remains in that in conducting an on-line tournament maintaining basic fundamental fairness in the tournament process has presented numerous challenges. Certain challenges include the rebalancing of participants from table to table during the tournament. Current systems randomly reassign participants to rebalance and reallocated tables. This randomness often creates fundamental unfairness in a tournament setting. The system and method of the present invention has addressed this randomness with particularity in addressing the manner in which tournament tables are evaluated and participants are rebalanced from their original table.

### SUMMARY OF THE INVENTION

### Brief Description of the Several Views of the Drawing

FIG. 1 is a flow chart showing the beginning steps of the system and method of the present invention.

FIG. 2 is a continuation of the flow chart from FIG. 1.

FIG. 3 is a continuation of the flow chart from FIG. 2.

FIG. 4 is a continuation of the flow chart from FIG. 3.

FIG. 5 is a continuation of the flow chart from FIG. 4.

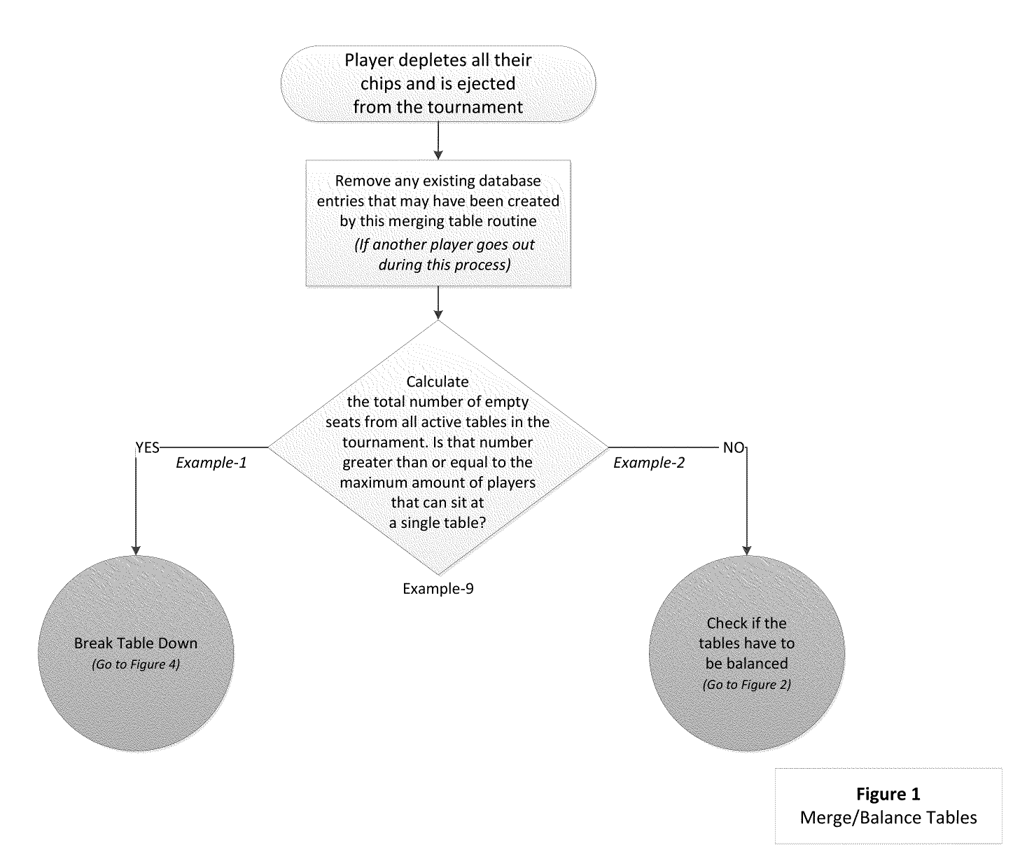

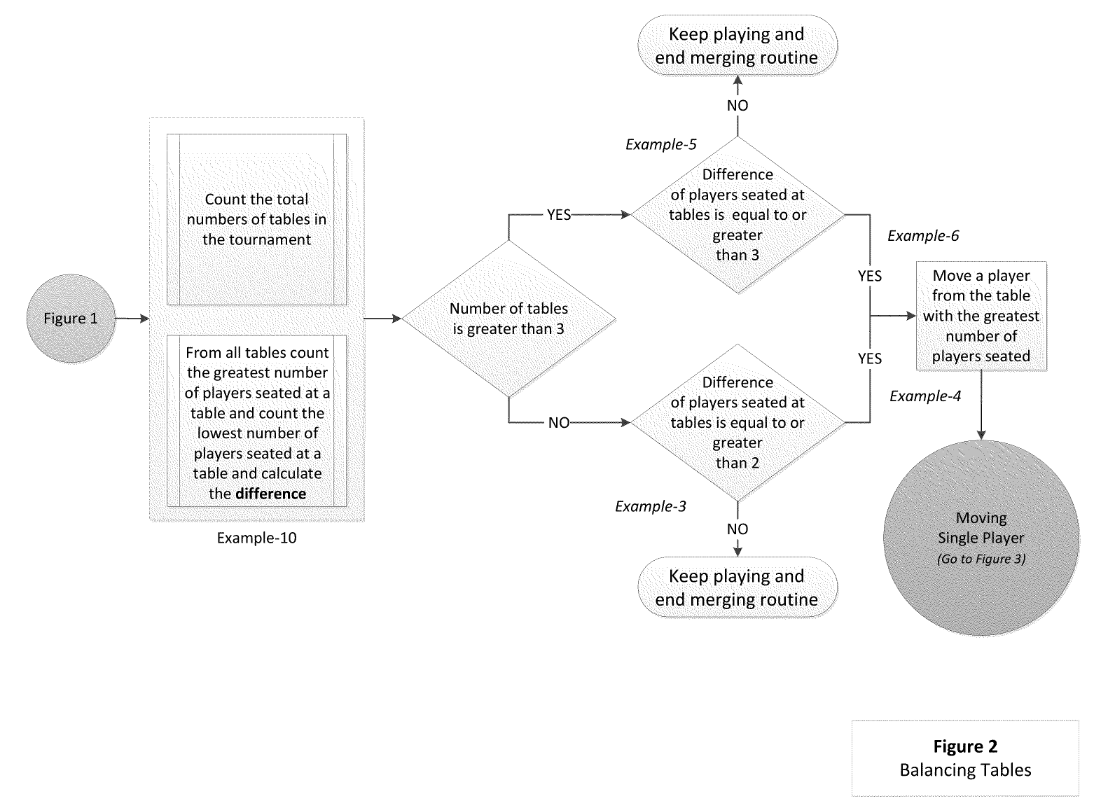

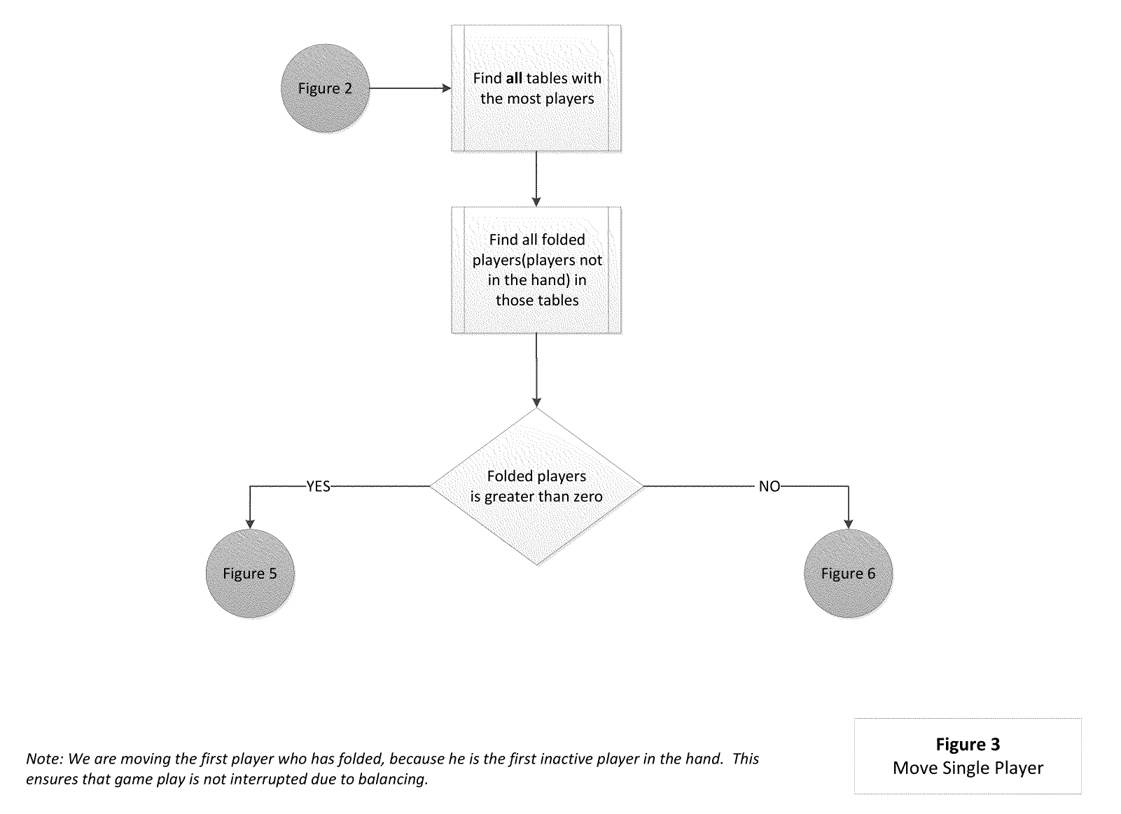

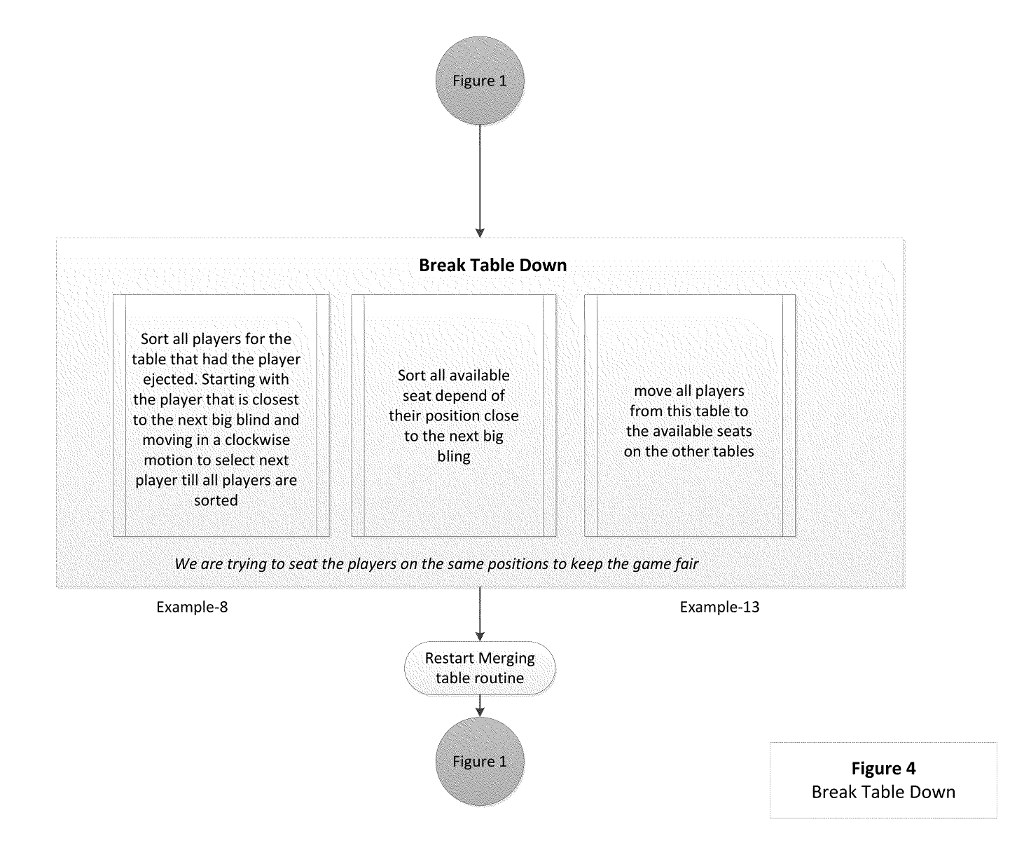

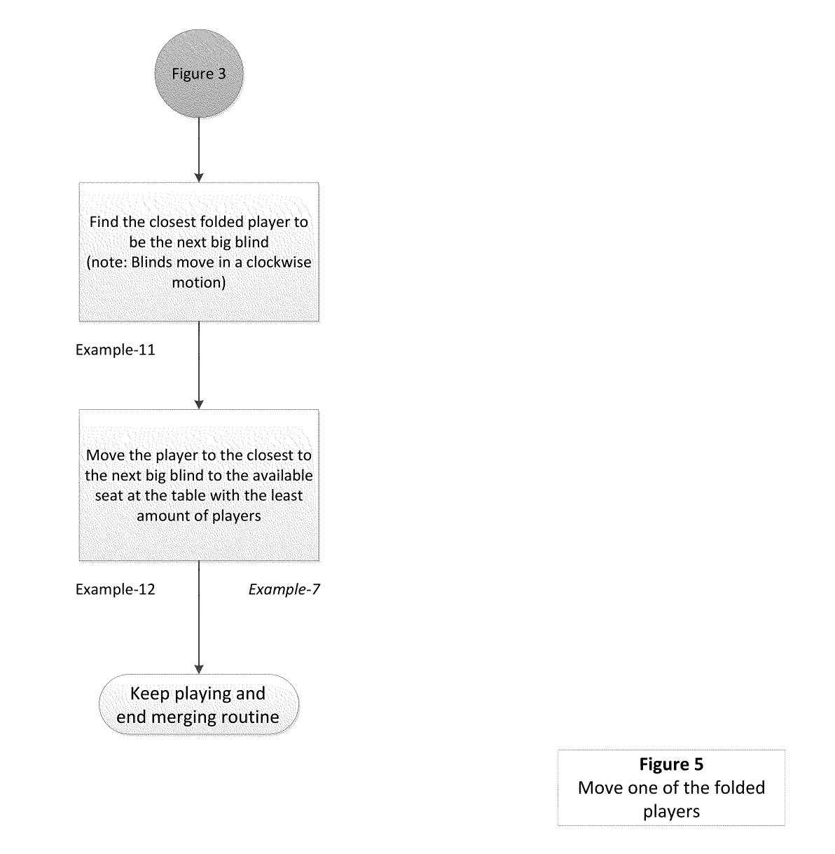

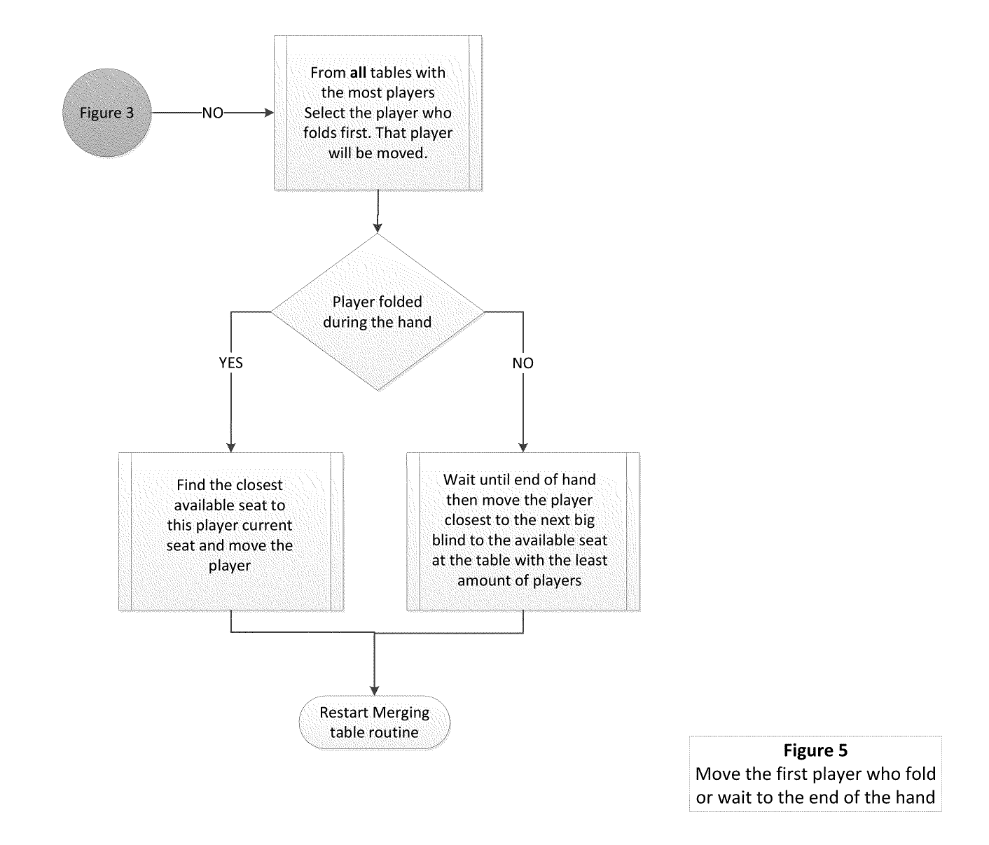

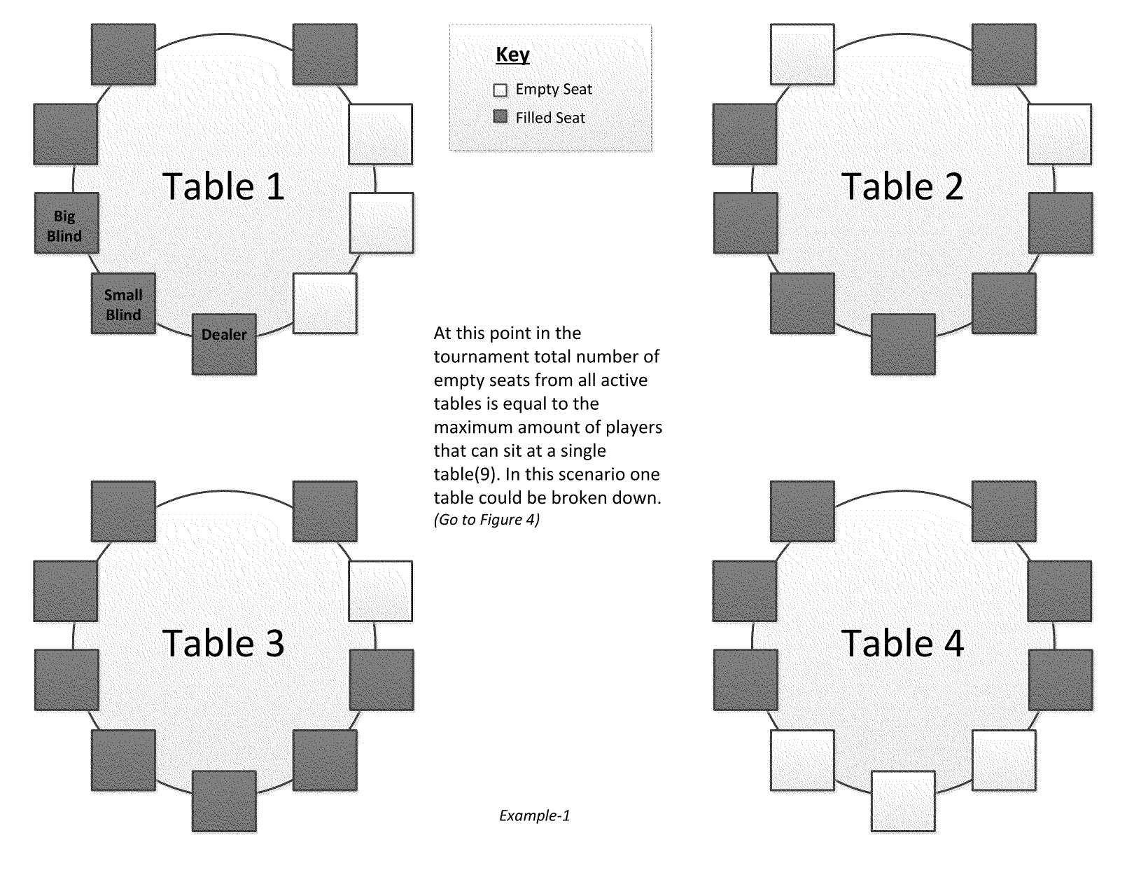

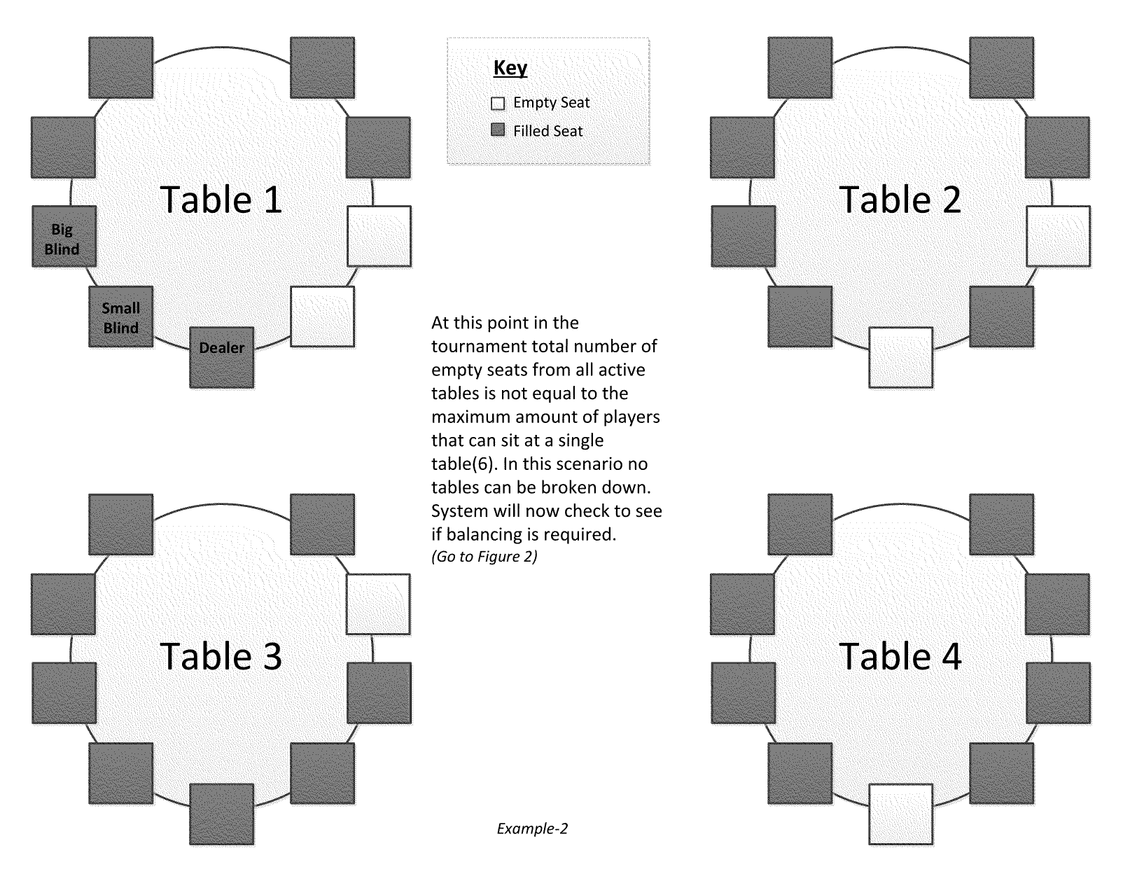

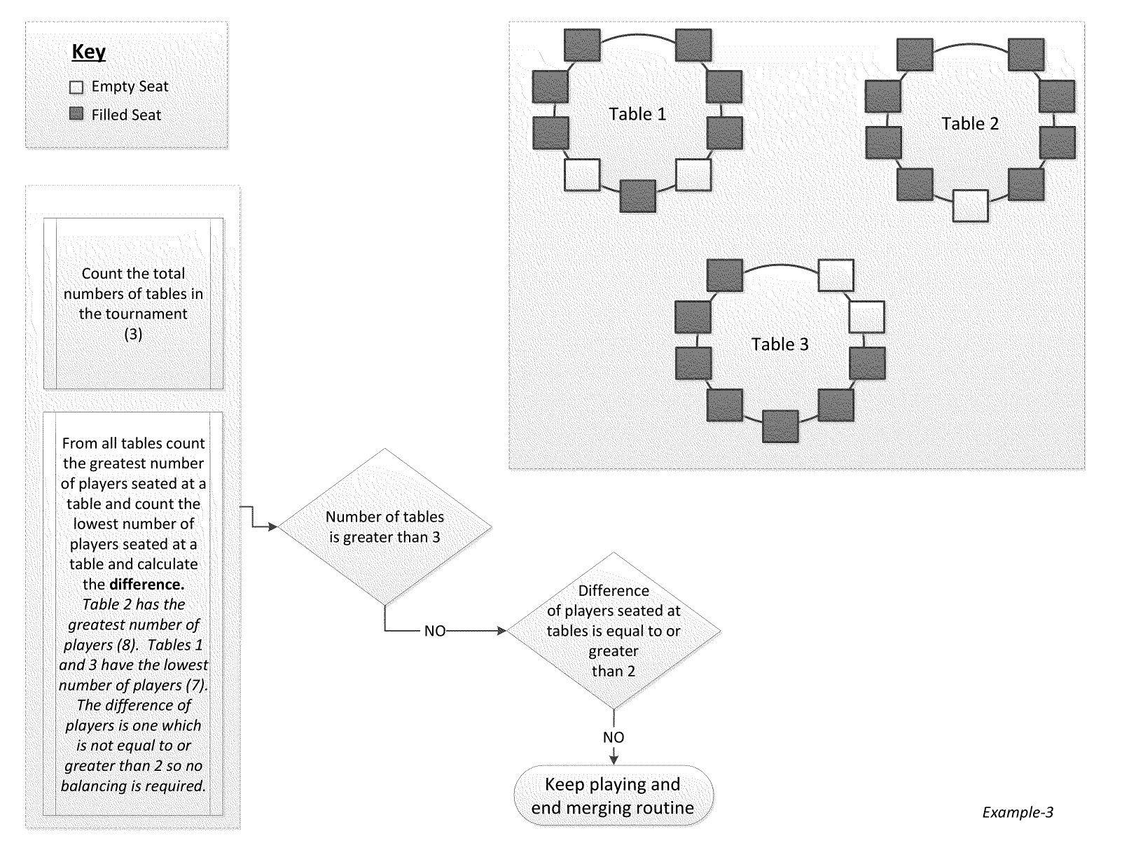

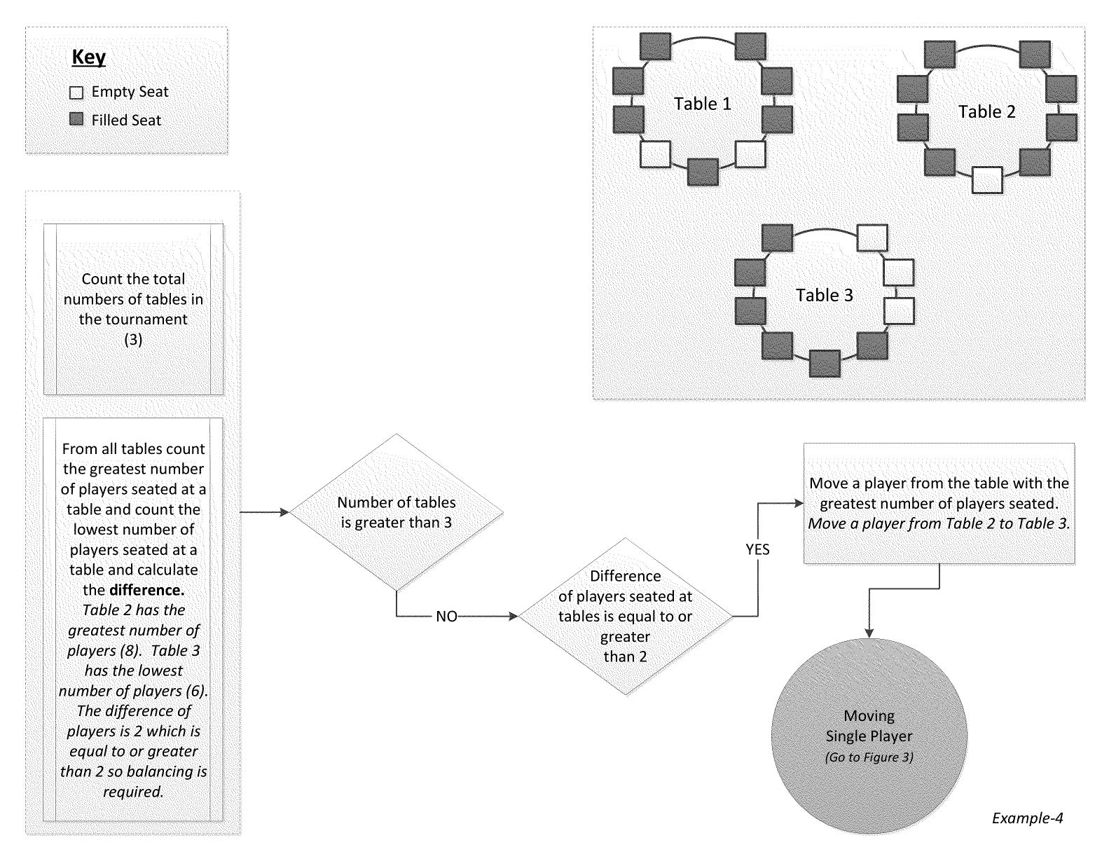

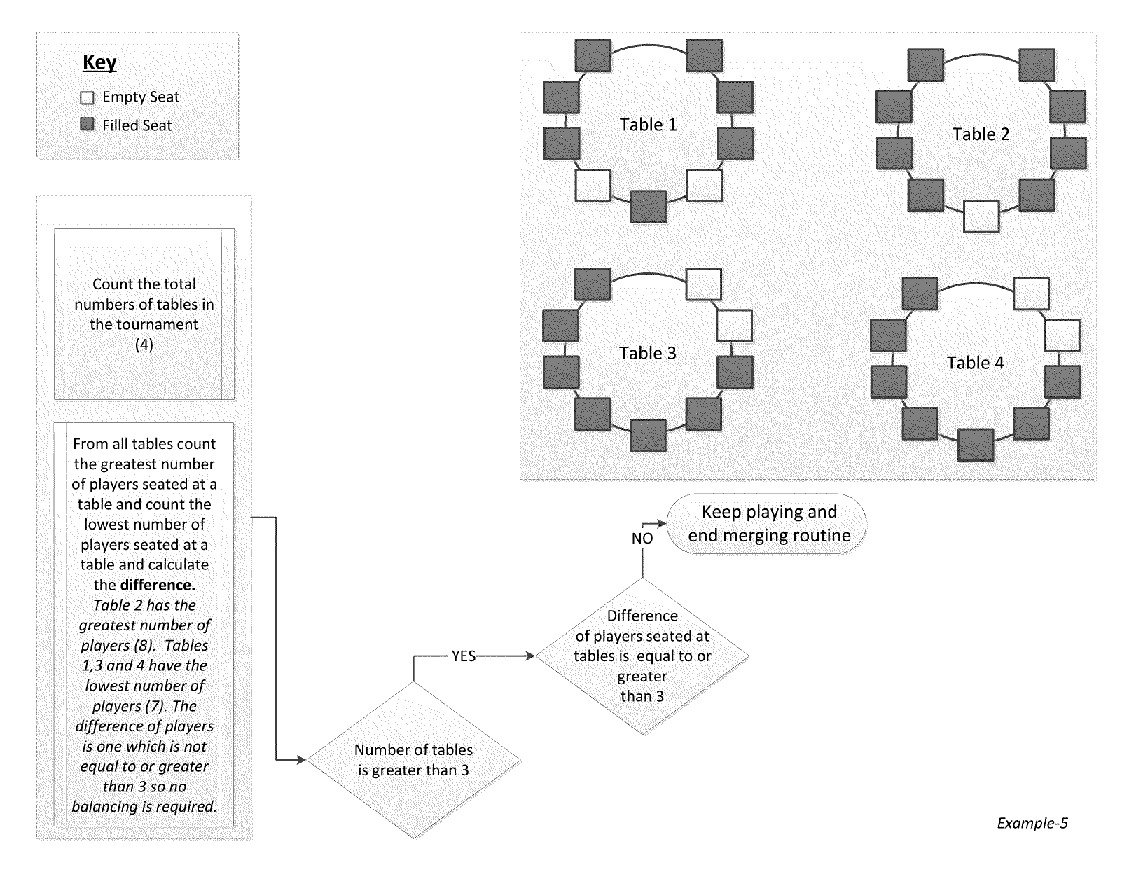

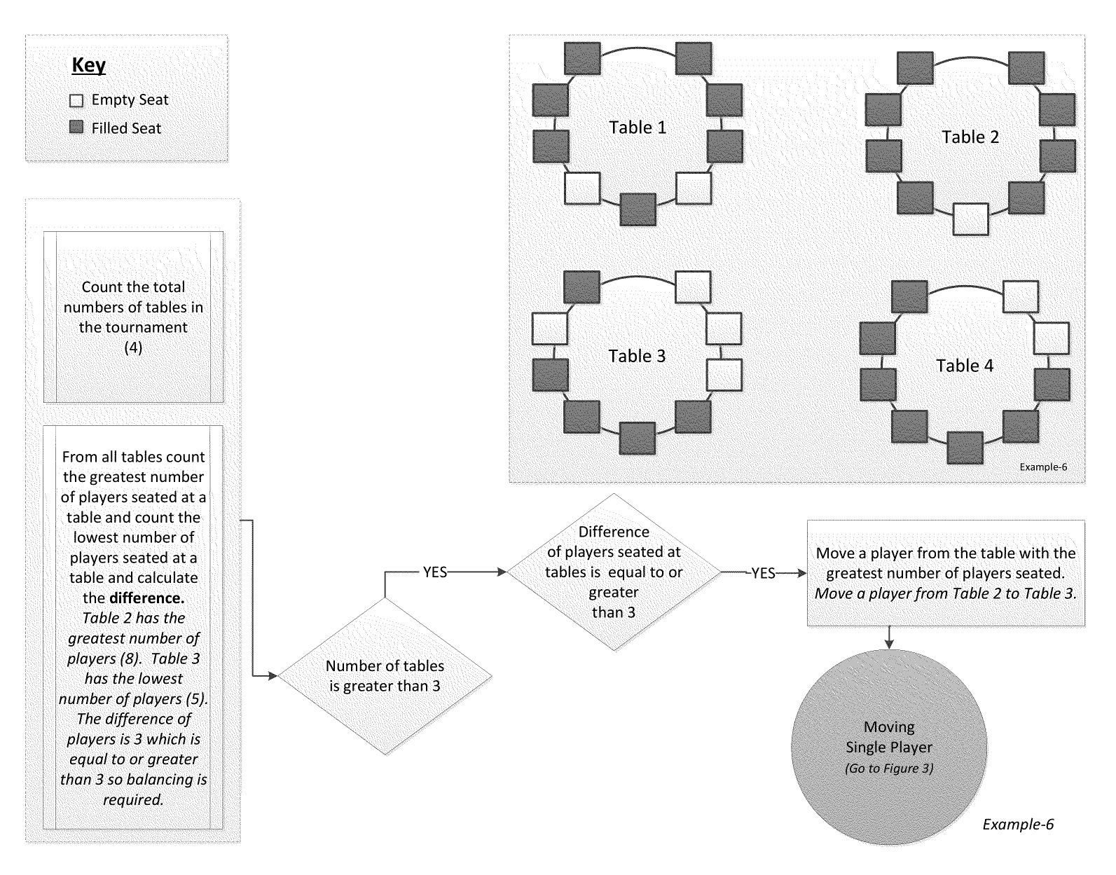

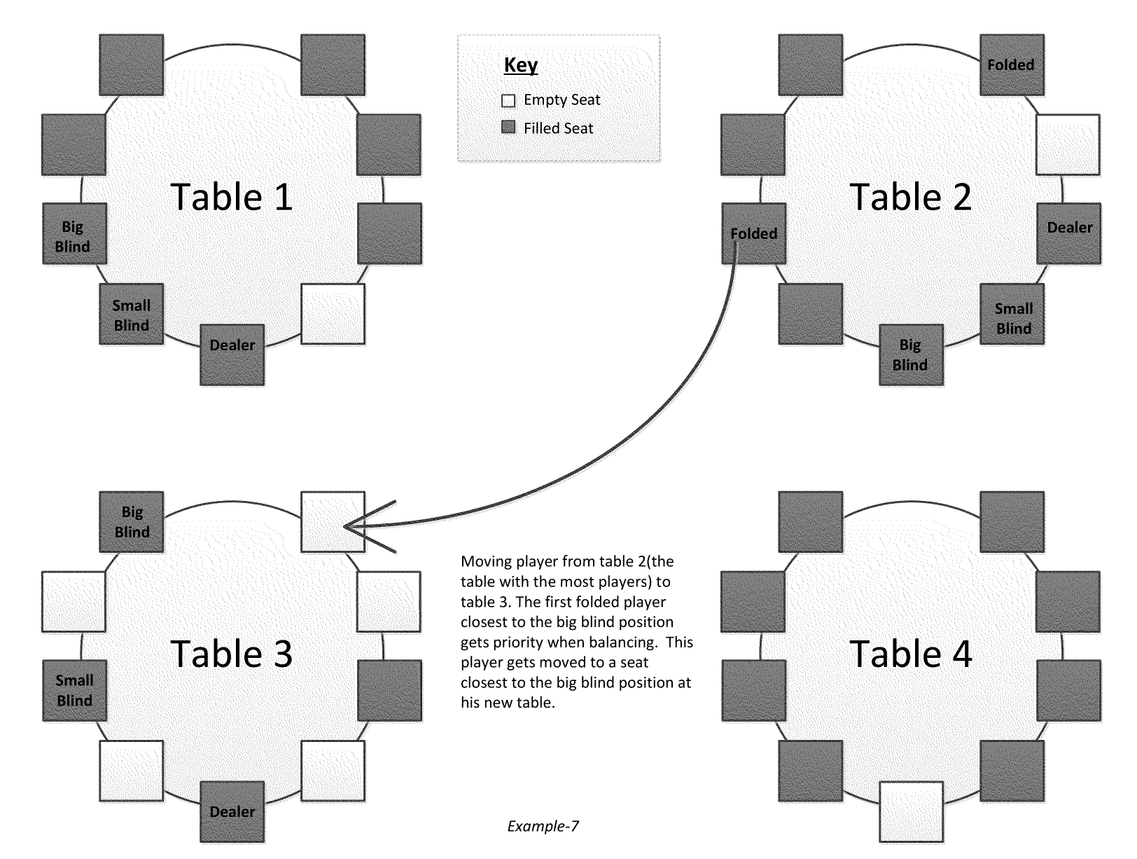

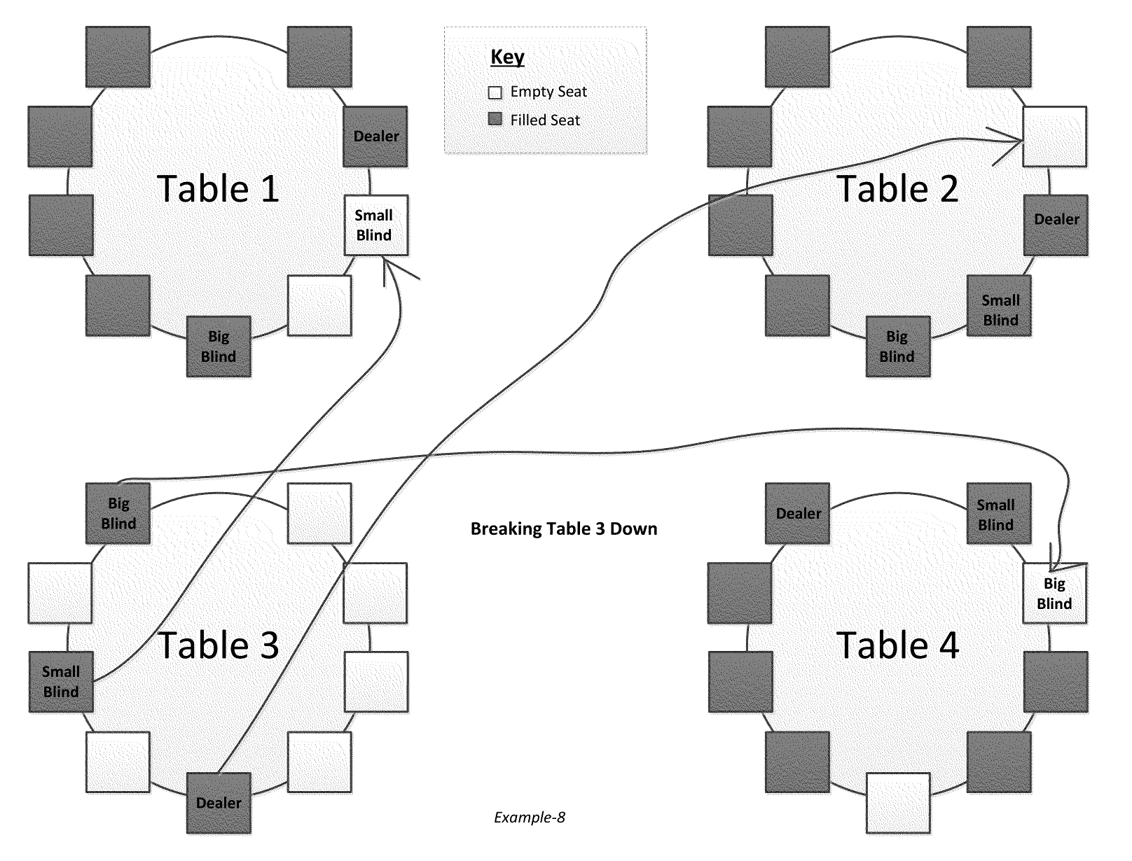

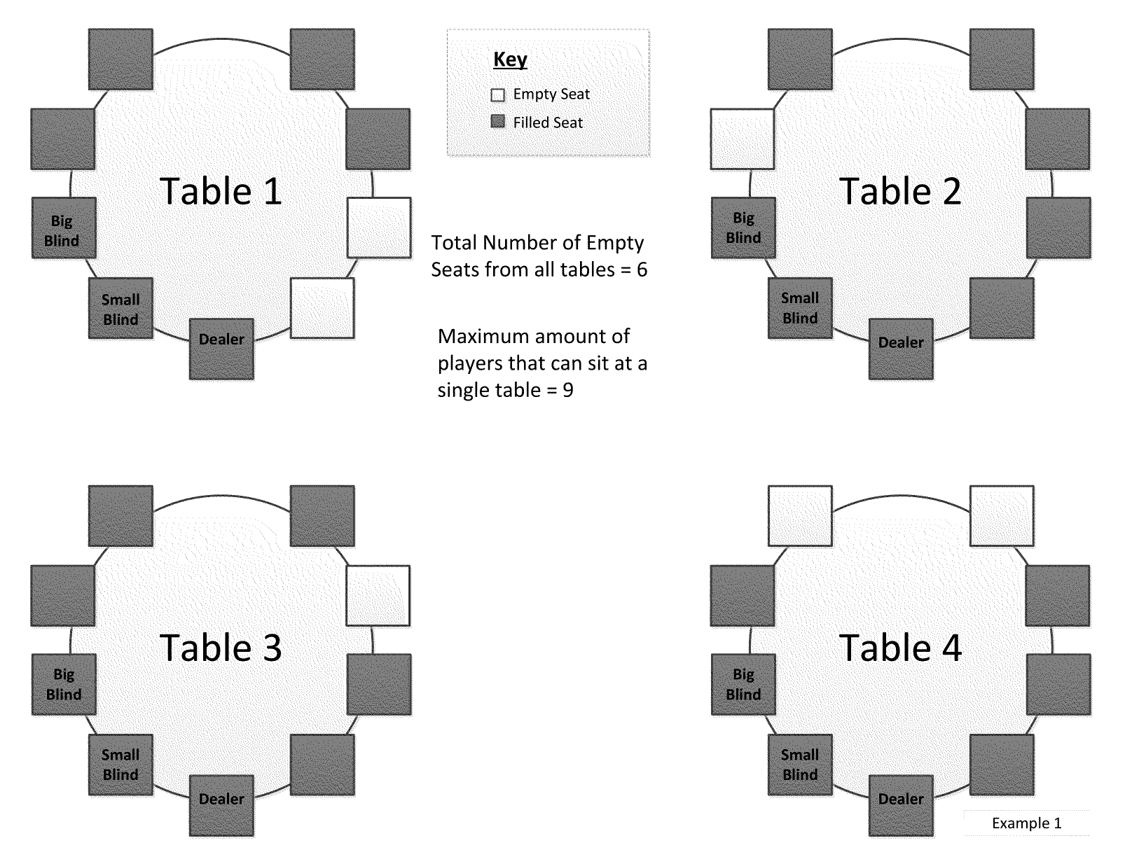

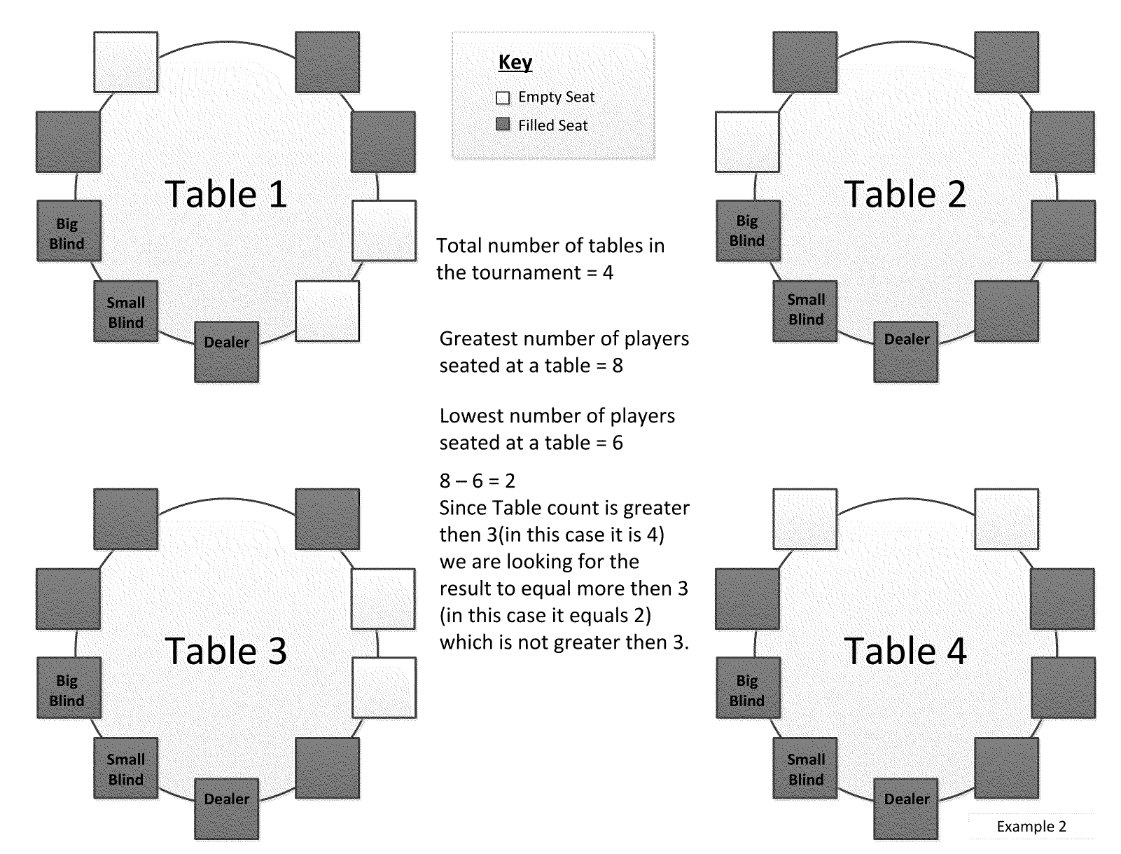

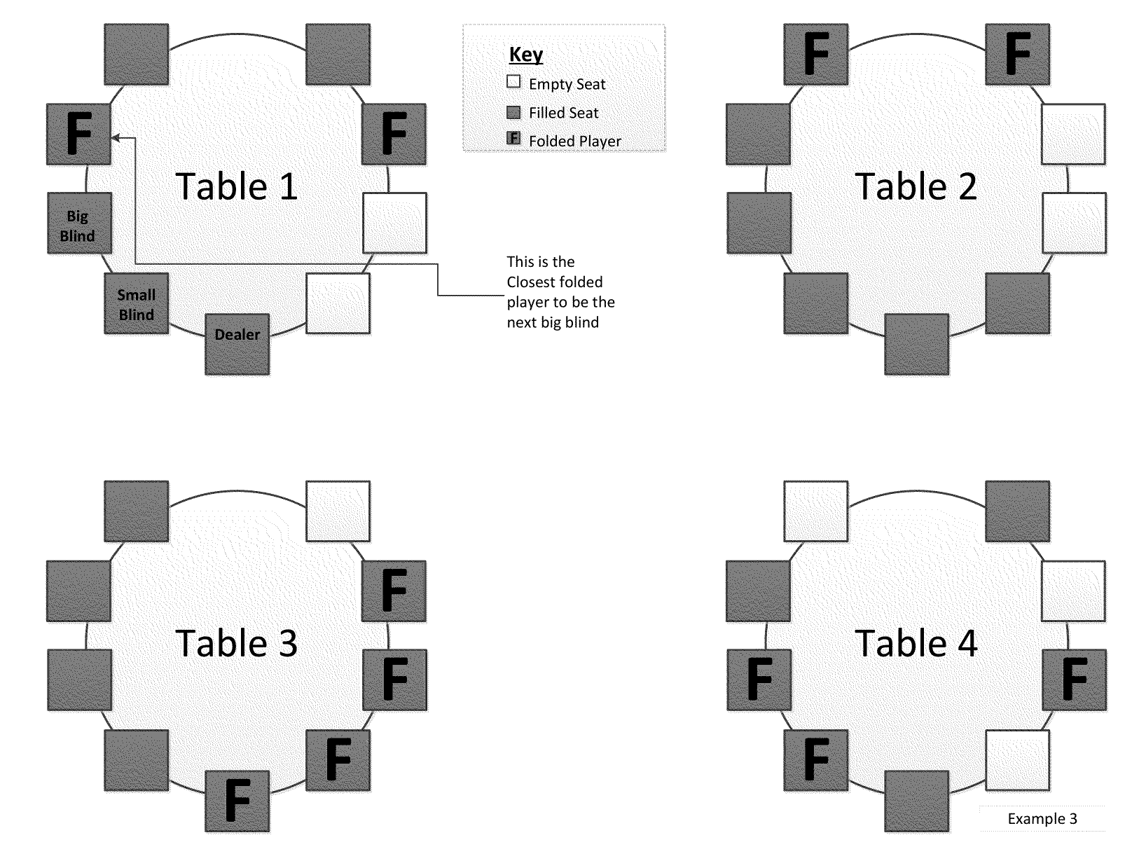

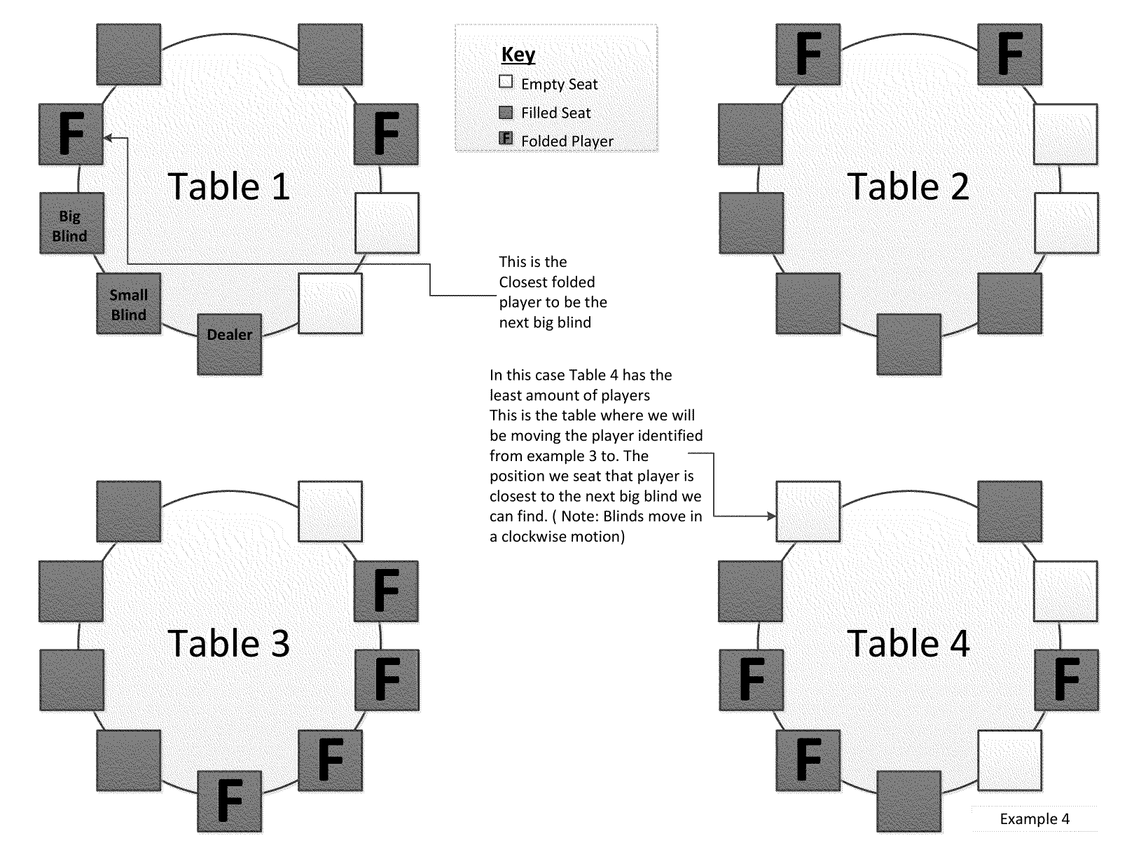

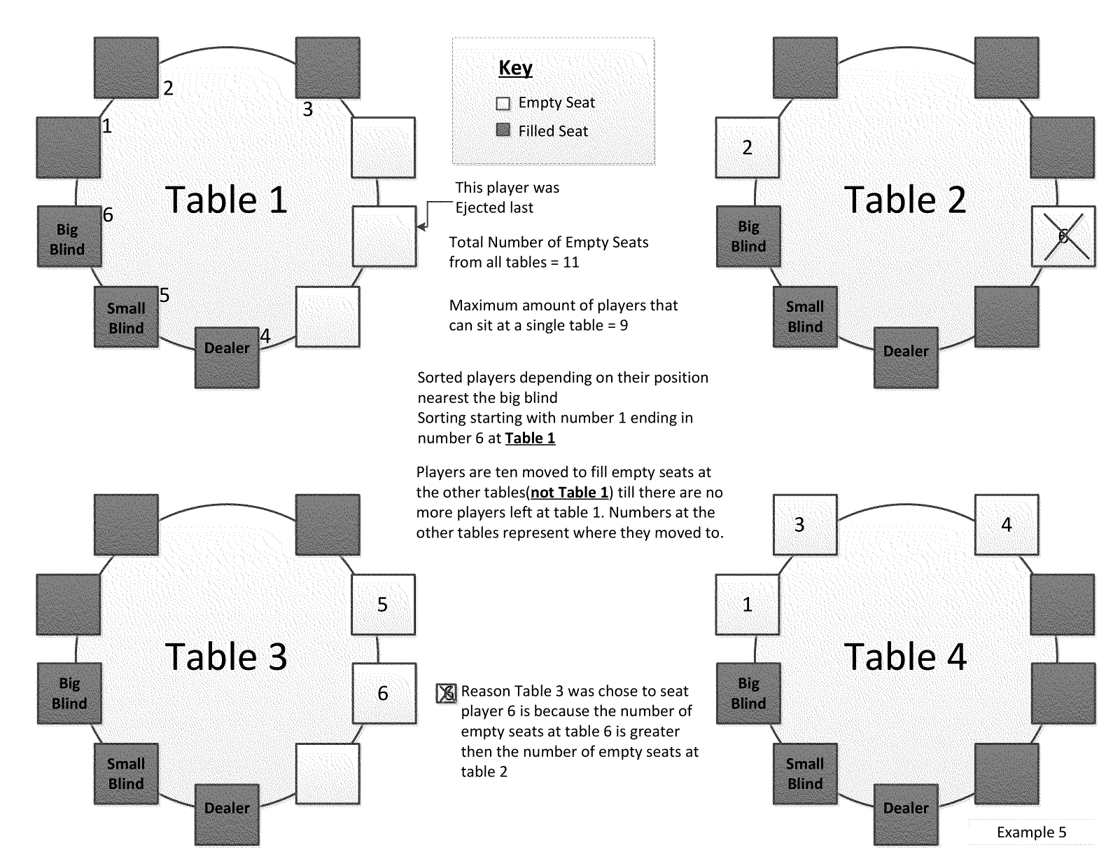

Also incorporated herein by reference are figures depicting sample embodiments as to the actual implementation of the system and method of the present invention. The embodiments are illustrative only and are not meant to limit the scope of the invention.

### DETAILED DESCRIPTION OF THE PREFERRED EMBODIMENT

In a preferred embodiment, the present invention includes a website whereby a plurality of users accesses a single site and said plurality of users are assigned particularized groups. This particular website includes the ability for the remote users to play together in a game of poker. Although the particular embodiment is for poker, the invention can be used in any gaming website in which tournament play is divided into groups and reallocation of groups is desired. The website is accessed by any acceptable electronic means including, but not limited to access by, PC, Tablet, Smart Phone, Cell Phone, and the like, they are assigned each to virtual tables. In one embodiment remote users are randomly assigned to individualized tables. In a second embodiment, users can select a particular table such that particular users can be seated together at the same table. As is generally understood in the game of poker, a table includes a minimum of two players and generally a maximum of ten. Once seated at a table, players initially acquire an initial set of chips. In one embodiment the acquisition of initial chips requires the purchase of said initial chips. In another embodiment the chips are given to each player upon log in and assignment to a table. Once assigned to a table, play begins according to the particularized rules of whichever poker game is being played.

Today it is commonly used in tournaments the rules of a game called Texas Hold 'em Poker as is known in the art. The games progress with a plurality of tables each having their own individualized games. As is understood in the art, persons lose chips throughout a particular game and at some point a person that has lost all of their chips is excluded from further play. A problem arises when, in a tournament setting the tables start to have attrition from tables leaving such that there are no longer substantially equally amount of players at each individualized table. The system and method of the present invention addresses this difficulty by reallocating players at various points during player attrition. In a preferred embodiment the system and method of the present invention relates to tournament play. In tournament play, as generally understood a person's chips remain active until their chip supply is completely depleted. The depletion of player chips is typically referred to as a player “busting”. The player busting is classified as a first actuating event. The actuating event alerts the system that a particular player is no longer active in the tournament. Once the first actuating event has completed the system will do a first query and said first query will count the global total of empty seats and compare the empty seats to the maximum seats allowable at a single table.

In a preferred embodiment, when the system engages in a first query in which the first empty seats are evaluated, if it's possible to consolidate players and close a particular table the system will proceed to do so. It is generally understood that the moving of players and consolidation of tables only occurs upon the completion of a hand at a particular table. That is to say tables are not consolidated and players are not moved until a completion of hand at that table.

Once the first query is complete, if any individual table is identified having a table with empty seats such that the players remaining can be moved to other tables in order to rebalance, the table in that particular tournament is subject to breakdown and the players are reallocated to other tables according to the present invention. The query further includes a survey of empty seats at all active tables in the tournament in order to assess breakdown of a table. Breakdown as generally understood in tournament poker means the table is no longer active with games being played.

As generally understood, when a player is moved to a table with an empty seat the system will query the various tables and look for the open player position at each table that is located closet open seat preceding the BB position to the player seated in the big blind position. If upon a system query more than one table is located having the exact spacing next to the big blind, placement is done by the system at “which position has been open the longest” . . . this will mitigate any concern over randomness.

In one embodiment, when a player is moved the player is never moved into a big blind position at a new table.

When the system initiates its counting of the global total of empty seats, if the empty seats are not equal to the maximum seats at a table, the system will proceed with the following steps. First the system will take an inventory and count the total number of tables currently in play in the tournament. Once the total number of tables is counted, in one embodiment, the system will look and count the total number of tables in play, and the system will make a determination as to the tables still in play and subject to balancing. If the tables still in play total three or less tables in play the system will identify the table with the largest amount of seats being used and the table with the fewest amount of seats being used and subtract the smallest from the largest and get a difference. If the difference is two or one players no balancing occurs and play continues. If the difference is three or greater players the system will balance the tables and move players as described herein. In a particular tournament where there are four or more tables still active and the difference is calculated, if the difference is two or less tables the tournament continues and there is no rebalancing of players. If the difference if three or more tables, the system will undertake the rebalancing. In order to make the rebalancing of players to have the most opportunity for the fair movement of players, the system will always look for the open seat closest to the big blind position. The system will look for the closest big blind seat before looking at the number of empty seats at each of the tables. The system and process continues in tournament play until a single table remains and that single table continues play until there is a single winner. That single winner is the winner of the tournament.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A system and method for managing an on-line poker tournament, said system comprising:
providing a program on a computer readable medium wherein said program is constructed and arranged for managing an on-line tournament;
providing access to said program by a plurality of tournament players;
counting the number of players accessing said system and creating a plurality of tournament poker tables based on the number of players accessing said tournament;
seating players at said created poker tables;
conducting hands of poker at each individual table;
rebalancing tables based on player attrition.

2. The method of claim 1 wherein said system and method evaluates said tables and determines if any one or more tables can be removed from tournament play.
